(19) United States
(12) Patent Application Publication
(10) Pub. No.: US 2014/0193544 A1
(43) Pub. Date: Jul. 10, 2014

(54) Biscuit Structure

(71) Applicant: Chin-Chih Chen, Taichung City (TW)

(72) Inventor: Chin-Chih Chen, Taichung City (TW)

(21) Appl. No.: 14/096,070

(22) Filed: Dec. 4, 2013

(30) Foreign Application Priority Data
Jan. 7, 2013 (TW) 102200290

(51) Int. Cl. A21D 13/00

(52) U.S. Cl. CPC A21D 13/0009
USPC 426/93

(57) ABSTRACT

A biscuit structure contains a body formed in a circular column shape or a flatly elongated block shape, and a mixing ingredient of the body includes corns, rice, brown rice, egg yolk powders, sugars, salts, palm oil, soy flour (mixed from soybeans, wheat, salts and sugars), and maltodextrin. The body is molded and baked, and then a sticky ingredient is applied on the body, thereafter a crushed nut ingredient is sprayed on the sticky ingredient of the body. The sticky ingredient is chocolate sauce or maltose syrup, and the crushed nut ingredient is crushed almonds or crushed peanuts. Thereby, the body of the biscuit structure is crispy and has a rich flavor after eating the sticky ingredient and the crushed nut ingredient.

### FIELD OF THE INVENTION

The present invent relates to a biscuit structure which is crispy and has a rich flavor after eating a sticky ingredient and a crushed nut ingredient of a body of the biscuit structure.

### BACKGROUND OF THE INVENTION

A conventional biscuit is a snack or dessert to satisfy consumer's appetite.

To enhance a delicious tasty, producers always add artificial ingredient in the conventional biscuit. In addition, the conventional biscuit is made from single ingredient, thus only having dull flavor.

The present invention has arisen to mitigate and/or obviate the afore-described disadvantages.

### SUMMARY OF THE INVENTION

The primary object of the present invention is to provide a biscuit structure which is crispy and has a rich flavor after eating a sticky ingredient and a crushed nut ingredient of a body.

To obtain the above objective, a biscuit structure provided by the present invention contains:
a body formed in a circular column shape or a flatly elongated block shape, and a mixing ingredient of the body includes corns, rice, brown rice, egg yolk powders, sugars, salts, palm oil, soy flour (mixed from soybeans, wheat, salts and sugars), and maltodextrin.

The body is molded and baked, and then a sticky ingredient is applied on the body, thereafter a crushed nut ingredient is sprayed on the sticky ingredient of the body.

The sticky ingredient is chocolate sauce or maltose syrup, and the crushed nut ingredient is crushed almonds or crushed peanuts.

### BRIEF DESCRIPTION OF THE DRAWINGS

FIG. 1 is a perspective view showing the assembly of a biscuit structure according to a first embodiment of present invention.

FIG. 2 is a cross sectional view showing the assembly of the biscuit structure according to the first embodiment of present invention.

FIG. 3 is a perspective view showing the assembly of a biscuit structure according to a second embodiment of present invention.

FIG. 4 is a cross sectional view showing the assembly of the biscuit structure according to the second embodiment of present invention.

### DETAILED DESCRIPTION OF THE PREFERRED EMBODIMENTS

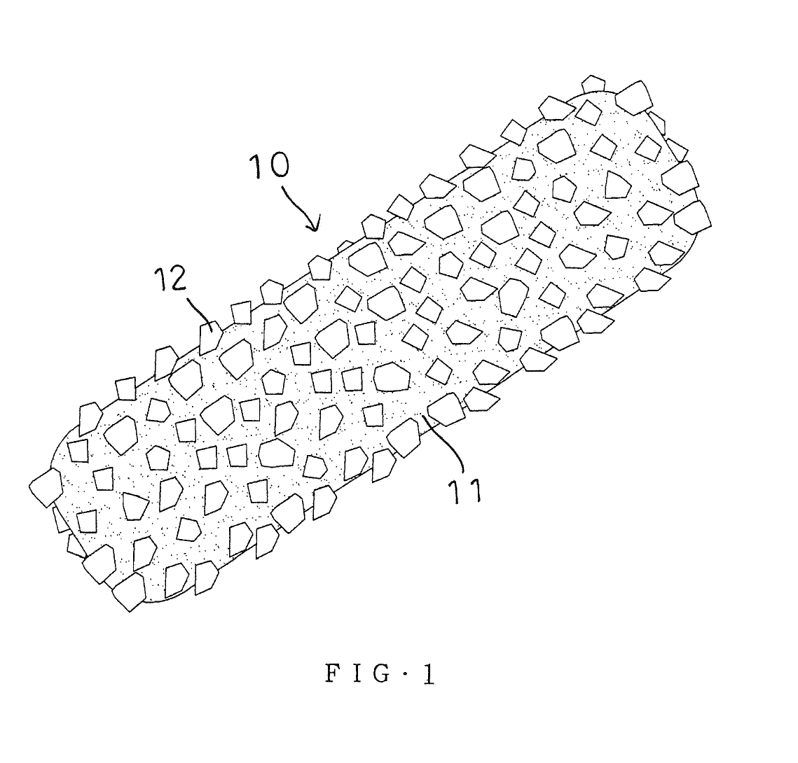

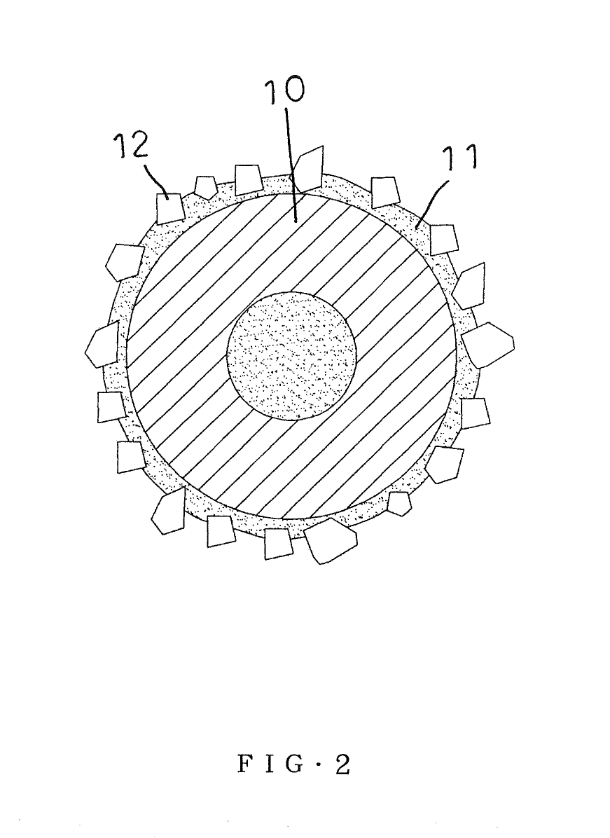

FIG. 1 is a perspective view showing the assembly of a biscuit structure according to a first embodiment of present invention. FIG. 2 is a cross sectional view showing the assembly of the biscuit structure according to the first embodiment of present invention. The biscuit structure comprises a body 10 formed in a circular column shape, and a mixing ingredient of the body 10 includes corns, rice, brown rice, egg yolk powders, sugars, salts, palm oil, soy flour (mixed from soybeans, wheat, salts and sugars), and maltodextrin. The body 10 is molded and baked, and then a sticky ingredient 11 is applied on the body 10, thereafter a crushed nut ingredient 12 is sprayed on the sticky ingredient 11 of the body 20. The sticky ingredient 11 is chocolate sauce or maltose syrup, and the crushed nut ingredient 12 is crushed almonds or crushed peanuts.

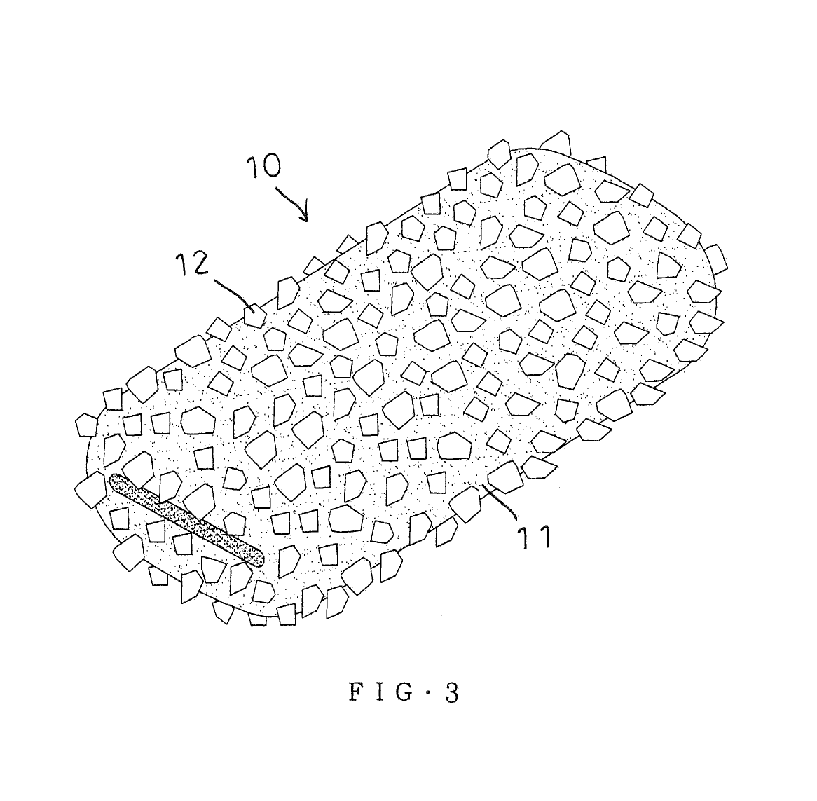

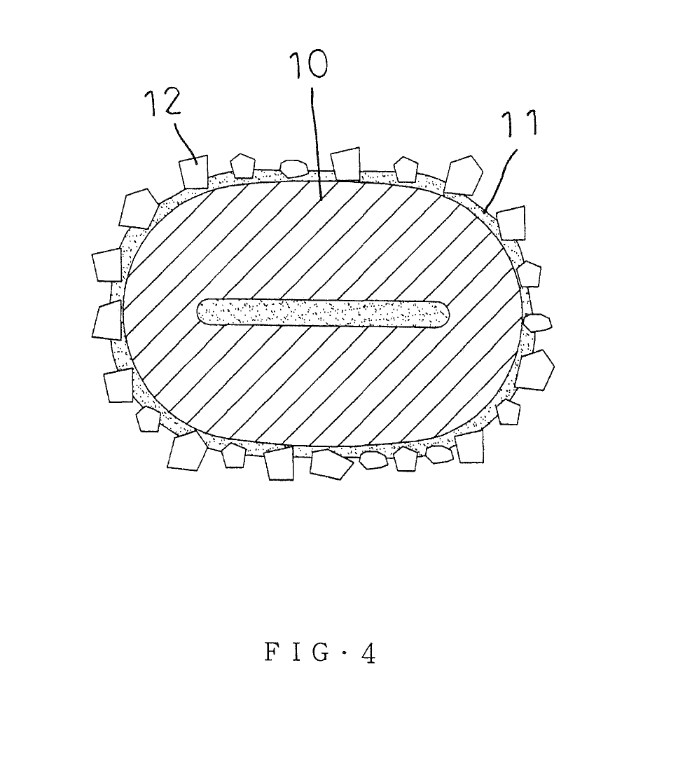

FIG. 3 is a perspective view showing the assembly of a biscuit structure according to a second embodiment of present invention. FIG. 4 is a cross sectional view showing the assembly of the biscuit structure according to the second embodiment of present invention. A difference of the biscuit structure of the second embodiment from that of the first embodiment comprises: a body 10 formed in a flatly elongated block shape.

Thereby, the body 10 is crispy and has a rich flavor after eating the sticky ingredient 11 and the crushed nut ingredient 12.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A biscuit structure comprising: a body on which a sticky ingredient is applied, and a crushed nut ingredient being sprayed on the sticky ingredient of the body, such that the rushed nut ingredient is stuck on the sticky ingredient of the body.

2. The biscuit structure as claimed in claim 1, wherein the body is formed in a circular column shape.

3. The biscuit structure as claimed in claim 1, wherein the body is formed in a flatly elongated block shape.

4. The biscuit structure as claimed in claim 1, wherein a mixing ingredient of the body includes corns, rice, brown rice, egg yolk powders, sugars, salts, palm oil, soy flour (mixed from soybeans, wheat, salts and sugars), and maltodextrin.

5. The biscuit structure as claimed in claim 1, wherein the sticky ingredient is chocolate sauce.

6. The biscuit structure as claimed in claim 1, wherein the sticky ingredient is maltose syrup.

7. The biscuit structure as claimed in claim 1, wherein the crushed nut ingredient is crushed almonds.

8. The biscuit structure as claimed in claim 1, wherein the crushed nut ingredient is crushed peanuts.
